(19) United States
(12) Patent Application Publication
(10) Pub. No.: US 2026/0062975 A1
(43) Pub. Date: Mar. 5, 2026

(54) CABLE TENSIONER WITH SPRING-BIASED TENSION LEVER AND RATCHET ARRANGEMENT

(71) Applicant: MAGNA CLOSURES INC., Newmarket (CA)

(72) Inventor: Milos PAVLOVIC, Newmarket (CA)

(21) Appl. No.: 19/318,225

(22) Filed: Sep. 3, 2025

Related U.S. Application Data
(60) Provisional application No. 63/690,967, filed on Sep. 5, 2024.

(51) Int. Cl. E05F 11/48; F16H 7/08; F16H 7/12

(52) U.S. Cl. CPC E05F 11/485; F16H 7/12; E05Y 2201/672; E05Y 2900/55; F16H 2007/081

(57) ABSTRACT

A cable tensioner for a window assembly of a motor vehicle closure panel has a baseplate supporting a tension lever for pivotal movement between a first position, whereat tension lever imparts a first tension in a cable, and a second position, whereat tension lever imparts a second tension in the cable, the second tension being substantially the same as the first tension. A ratcheting arrangement prevents tension lever from returning toward the first tension position. Tension lever is biased toward the first position by a biasing member. Biasing member has a first end operably fixed to baseplate and a second end arranged in biased engagement with tension lever, wherein biasing member is under preload to maintain tension lever in constant engagement with cable.

### CROSS-REFERENCE TO RELATED APPLICATIONS

This application claims the benefit of U.S. Provisional Application Ser. No. 63/690,967, filed Sep. 5, 2024, which is incorporated herein by reference in its entirety.

### FIELD

The present disclosure relates generally to vehicle door assemblies, and more particularly to window cable systems therefor.

### BACKGROUND

This section provides background information related to automotive door window cable systems and cable tensioners therefor and is not necessarily prior art to the concepts associated with the present disclosure.

A vehicle door commonly has a window operable to move downwardly and upwardly between open and closed positions. Modern vehicles typically have a power actuated system configured to drive a cable in opposite directions to move the window between the open and closed positions. To inhibit noise and to maintain efficient movement of the cable and efficient corresponding movement of the window, the cable is commonly placed under tension by an “in-line” cable tensioner 10′, as shown in FIG. 2A, wherein the cable tensioner is disposed between and joined to ends of the cable, thereby occupying an interrupted segment of the cable. As such, the cable tensioner adds to the overall length of the cable tensioner, and thus, increase the difficulty of packaging/routing of cable and provide less design options.

Thus, there remains a need to develop alternative arrangements for cable tensioners for use in cable systems of power-operated window systems which improves functionality, reduces complexity and cost, and improves the reset function of the latch.

### SUMMARY OF THE INVENTION

This section provides a general summary of the disclosure, and is not intended to be a comprehensive and exhaustive listing of all of its features or its full scope.

In accordance with one aspect of the disclosure, a cable tensioner for imparting tension on a cable of a powered window system of a motor vehicle closure panel is provided. The cable tensioner includes a support body and a cam pivotably supported by the support body for pivotal movement between a first position, whereat the cam contacts the cable and deflects the cable over a first angle about the cam, and a second position, whereat the cam contacts the cable and deflects the cable over a second angle about the cam, the second angle being greater than the first angle. Further, a cam biasing member imparts a bias on the cam to maintain the cam in constant contact with the cable between the first position and the second position, and a unidirectional clutch is configured to allow the cam to move from the first position toward the second position and to prevent movement of the cam away from the second position toward the first position.

In accordance with another aspect of the disclosure, the unidirectional clutch includes a plurality of ratchet teeth and a pawl.

In accordance with another aspect of the disclosure, the pawl is biased into engagement with the ratchet teeth by a pawl biasing member.

In accordance with another aspect of the disclosure, a pin extends laterally outwardly from the support body and a lug extends laterally outwardly from the cam, wherein the cam biasing member has a first end coupled to the pin and a second end biased into engagement with the lug.

In accordance with another aspect of the disclosure, the cam biasing member is a spiral torsion spring.

In accordance with another aspect of the disclosure, the cam has a first end region supported for rotation about a pin axis of a pin extending laterally from the support body and a second end region configured to be biased into contact with the cable.

In accordance with another aspect of the disclosure, the first end region has a plurality of ratchet teeth configured for engagement with a pawl, wherein the pawl is configured ratchet over the plurality of ratchet teeth to allow the cam to move from the first position toward the second position and to lock against the plurality of ratchet teeth to prevent the cam from moving away from the second position toward the first position.

In accordance with another aspect of the disclosure, the pawl is biased into engagement with the ratchet teeth by a pawl biasing member, the pawl biasing member allowing the pawl to deflect in ratcheting fashion over the plurality of ratchet teeth as the cam moves from the first position toward the second position, and maintaining the pawl in locked engagement with at least one of the plurality of ratchet teeth to prevent the cam from moving away from the second position toward the first position.

In accordance with another aspect of the disclosure, a lug extends laterally outwardly from the cam, wherein the cam biasing member has a first end coupled to the pin and a second end biased into engagement with the lug.

In accordance with another aspect of the disclosure, the cam biasing member is a spiral torsion spring.

In accordance with another aspect of the disclosure, a carrier for a carrier module of a motor vehicle door assembly is provided. The door assembly has an inner panel and an outer panel defining a door panel structure with the inner panel having an opening to an internal door cavity between the inner panel and the outer panel. The carrier includes a carrier body bounded by an outer periphery configured for attachment to the inner panel to at least partially close off the opening. A cable and pulley-type window lift system is operably attached to the carrier body. The cable and pulley-type window lift system has a plurality of pulleys and a cable entrained about the plurality of pulleys. A support body of a cable tensioner is operably fixed to the carrier body, and a cam is supported by the support body for pivotal movement between a first position, whereat the cam contacts the cable and deflects the cable over a first angle about the cam, and a second position, whereat the cam contacts the cable and deflects the cable over a second angle about the cam, the second angle being greater than the first angle. A cam biasing member imparts a bias on the cam to maintain the cam in constant contact with the cable between the first position and the second position. A unidirectional clutch is configured to allow the cam to move from the first position toward the second position and to prevent movement of the cam away from the second position toward the first position.

In accordance with another aspect of the disclosure, a method of maintaining tension within a cable of a cable and pulley-type window lift system of window assembly of a motor vehicle closure panel is provided. The method includes: disposing a cam in contact with the cable; biasing the cam with a cam biasing member, and arranging a unidirectional clutch in operable communication with the cam to allow the cam to rotate toward the cable in response to a bias imparted by the cam biasing member from a first position, whereat the cam contacts the cable and deflects the cable over a first angle about the cam, to a second position, whereat the cam contacts the cable and deflects the cable over a second angle about the cam, the second angle being greater than the first angle, wherein the unidirectional clutch prevents the cam from rotating away from the second position toward the first position.

In accordance with another aspect of the disclosure, the method includes providing the unidirectional clutch with a plurality of ratchet teeth on the cam and a pawl biased for ratcheting engagement with the plurality of teeth.

### BRIEF DESCRIPTION OF THE DRAWINGS

The drawings described herein are for illustrative purposes only of selected non-limiting embodiments and are not intended to limit the scope of the present disclosure. In this regard the drawings include:

FIG. 1 illustrates a vehicle having a closure panel including a cable tensioner constructed in accordance with an aspect of the disclosure;

FIG. 2A is a wet side of a carrier of the carrier module illustrating an in-line cable tensioner according to the prior art;

FIG. 2B is a wet side of a carrier of the carrier module illustrating the cable tensioner in accordance with an aspect of the disclosure;

FIG. 3 illustrates the cable tensioner of FIG. 2B and a unidirectional clutch thereof;

FIG. 4A illustrates the cable tensioner in accordance with an aspect of the disclosure, with a cable tensioner shown in solid in an initial assembly state position against a cable of a window cable system and in phantom in an advanced use state position against the cable; and

FIG. 4B is a side view of the cable tensioner of FIG. 3 taken along the line AA.

### DETAILED DESCRIPTION OF EXAMPLE EMBODIMENTS

In general, example embodiments of a carrier module of a motor vehicle, of the type configured including window regulators and cables with a cable tensioner to be installed within an internal door cavity of a motor vehicle door assembly and having a carrier configured to separate a wet side from a dry side of the door assembly, constructed/manufactured in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

The term “substantially” or “generally” is used herein to describe disclosed or claimed embodiments, and modifies a value or relative characteristic disclosed or claimed in the present disclosure. In such instances, “substantially” or “generally” signifies that the value or relative characteristic it modifies is within ±0%, 0.1%, 0.5%, 1%, 2%, 3%, 4%, 5% or 10% of the value or relative characteristic.

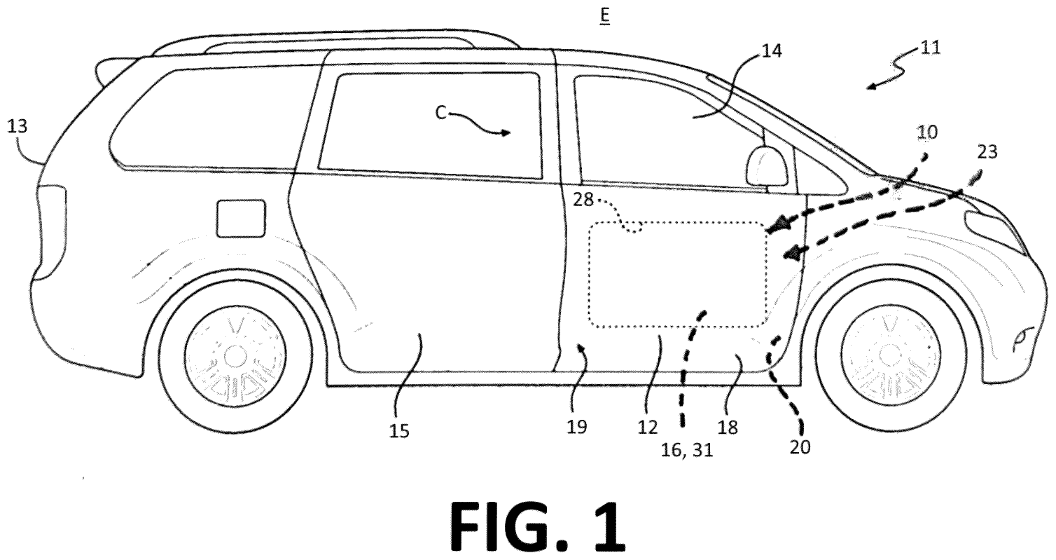

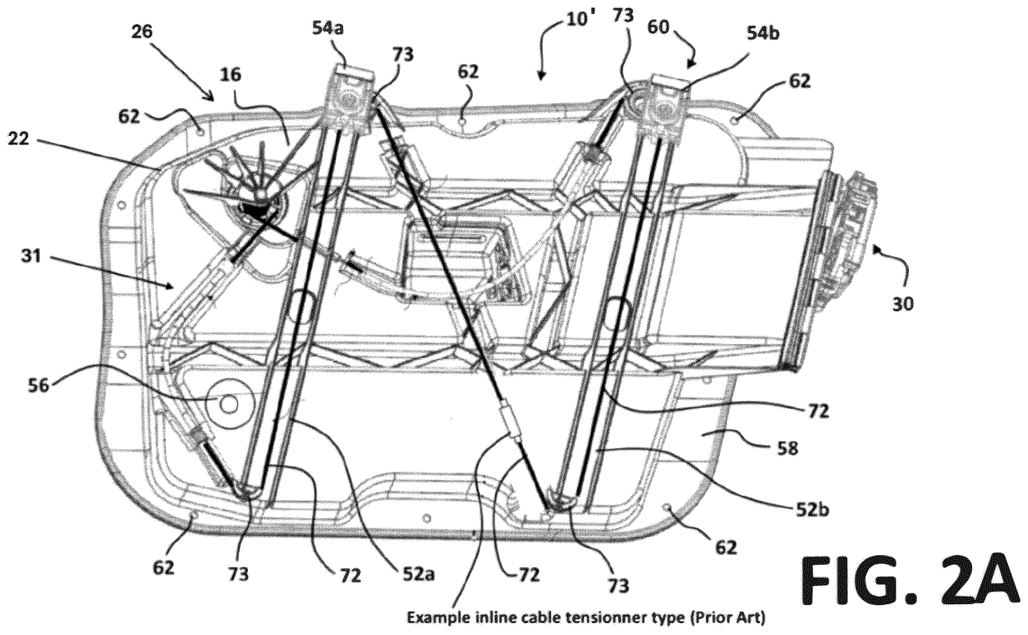

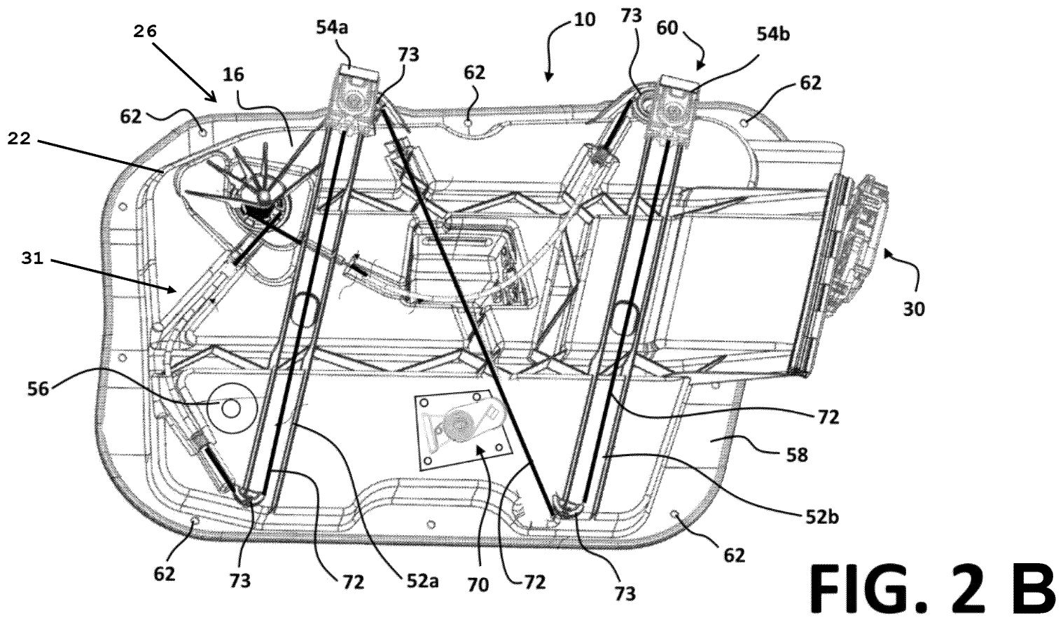

FIG. 1 shows a vehicle 11 having a plurality of motor vehicle closure panel assemblies, also referred to as door or panel assemblies, including, by way of example and without limitation, front door panel assemblies 12, a rear hatch lift gate closure panel assembly 13, a sliding side door panel assembly 15, wherein one or more of the panel assemblies 12 includes a door module, also referred to as carrier module or carrier assembly 10 (FIG. 2), constructed in accordance with an aspect of the disclosure. The carrier assembly 10 includes a carrier 16, wherein FIG. 2 shows a first side 31 (wet-side) of the carrier assembly 10 of one of the panel assemblies, and shown as one of the front door panel assemblies, referred to hereafter as door 12, by way of example and without limitation. It is to be recognized that the carrier assembly 10 can be configured having any surface contours and outer peripheral shape as desired for application with any of the panel assemblies of FIG. 1. The first side 31 of the carrier assembly 10 shown in FIG. 2B is referred to as the “wet-side” because, when the carrier assembly 10 is installed in a vehicle closure panel of vehicle 11, the first side 31 faces outwardly, away from the passenger compartment, also referred to as interior cabin C, and may be exposed to an ambient external environment E as a result of apertures in the panel assembly (such as the large slot through which a window 14 moves between open and closed positions). In contrast, an opposite second side (not shown) of the carrier assembly 10 is referred to as the “dry-side” because, when carrier assembly 10 is installed in a vehicle closure panel of vehicle 11, the carrier 16 of carrier assembly 10 seals the interior cabin C of the motor vehicle 11 against the ambient external environment E such that the second side, which faces toward the interior cabin C, is protected from the external environment E and remains dry.

Carrier assembly 10 is shown to include the carrier 16, which is generally plate-like in configuration, with specifically and precisely located undulating contours, also referred to as surface profiles, provided as desired for the intended components and application, thereby providing the carrier 16 having a variety of integrally formed three-dimensional features within the material of the carrier 16. Carrier 16 has a carrier body 58 configured to be fixed to door panel body 19, such as to inner door panel 20, as discussed above, and can include a plurality of fastener through openings 62 adjacent the outer periphery 26 for receipt of fasteners (not shown) therethrough. Carrier 16 holds a variety of functional door hardware components. Carrier 16 can be formed as a structural component in the sense that the door hardware components may be mounted thereto without requiring additional fasteners to mount the components to the structural panel assembly after installation of carrier assembly 10 therein. As is understood, front door 12 includes a structural door panel body, referred to hereafter as door panel structure or body 19, made up of a sheet metal inner door panel, also referred to as inner panel 20, joined to a sheet metal outer door panel, also referred to as outer panel 18, along their outer peripheral edge regions and/or elsewhere so as to define an internal door cavity 23 between the inner and outer door panels 20, 18. The window 14 is stored in internal door cavity 23 when moved to its opened position. Carrier 16 includes a circumferentially, continuously extending sealing bead 22 which is configured to extend adjacent an outer periphery 26 of carrier 16 and surround an opening 28 (FIG. 1) in inner door panel 20 in sealed relation thereabout when carrier 16 is assembled and mounted against inner door panel 20. Since carrier 16 is impervious to water, the sealing bead 22 acts to prevent infiltration of debris and other forms of contamination, including fluid and moisture, from the wet side 31 to the dry side into the passenger interior cabin C.

The carrier assembly 10 is shown carrying most, if not all, of the door hardware components for front door 12, by way of example and without limitation. Generally speaking, the functional hardware components secured to carrier 16 can, as shown, include the power-operated latch assembly 30, a power-operated window regulator 32, amongst other functional hardware features associated with latching and unlatching latch assembly 30, with at least some of the functional hardware components being electrically coupled to an ECU (not shown). Carrier 16 further supports a pair of guide rails 52A, 52B which support corresponding lift brackets 54A, 54B for translational movement thereon. Lift brackets 54A, 54B support window 14 for movement along rails 52A, 52B between opened and closed positions. A cable and pulley-type window lift system 60 is operably attached to carrier body 58 and connects lift brackets 54A, 54B to a power-driven drum associated with power-operated window regulator 32. In addition to the door hardware components, carrier assembly 10 is further shown, by way of example and without limitation, as supporting a speaker 56.

A cable tensioner 70 is provided, in accordance with the disclosure, to impart a bias on a cable 72 entrained about a plurality of pulleys 73, which are part of the cable and pulley-type window lift system 60, that operably connects the lift brackets 54A, 54B to the power-driven drum associated with the power-operated window regulator 32 of the cable and pulley-type window lift system 60. The tension imparted by cable tensioner 70 improves the accuracy of desired movement of the window 14 between raised and lowered position, and in particular, over short distances, such as when window 14 is desired to be moved over a small extent, sometimes referred to as a “short drop,” when a motor of the power-operated window regulator 32 is energized, such as when “cracking” the window 14 from a fully closed position to a slightly open position.

Cable tensioner 70 can provide greater end of life travel to continue to provide tension on cable 72 as compared to known “in-line” tensioners discussed in the Background. Cable tensioner 70 has a spring-biased tension lever, also referred to as tension lever or cam 74, with a unidirectional clutch, shown provided as a ratchet arrangement, also referred to as ratchet assembly 75, by way of example and without limitation. The ratchet assembly 75 forming unidirectional clutch has a minimal number of operating components, and can eliminate the need for a cable conduit, also referred to as cable sheath, through which a cable of an “in-line” tensioner typically slides, though, if desired, a cable conduit can be provided to facilitate routing of cable 72 about relatively small radius bends/corners. Cable tensioner 70 is minimal in size and is out-of-line, in offset relation, from the cable 72, thereby not adding to the overall length of cable 72. The tension lever (cam) 74 acts continuously and directly on cable 72, and imparts a continuous force F on cable 72, wherein force F acts in inclined relation on cable 72 relative to a lengthwise extending axis, along which cable 72 extends, of cable 72. The force F imparted by cam 74 on cable 72 maintains cable 72 under constant tension load to remove any potential slack and potential buildup of slack within cable 72 over the useful life of carrier assembly 10 and cable tensioner 70, thereby providing efficient, accurate, and repeatable performance of cable tensioner 70. The force F imparted by cam 74 on cable 72 can be minimized as a result of acting as a lever arm in inclined fashion, such as obliquely and/or transversely on cable 72. Cable tensioner 70 can be located in a variety of locations along cable 72, as desired, thereby improving flexibility of design of closure panel assembly 12. Cable tensioner 70, being a separate component from cable 72, can be assembled at any desired stage of assembly of closure panel assembly 12, including as a last assembly operation, thereby improving flexibility and efficiency of manufacture of closure panel assembly 12.

Cable tensioner has a baseplate, also referred to as housing or support body 76, configured for operable attachment to carrier 16, such as via one or more attachment mechanism. In the non-limiting embodiment, a plurality of fastener openings 78 are provided in support body 76 for receipt of a suitable fastener, such as screws, snaps, clips, or the like. Support body 76 can be formed of any suitable rigid material, including plastic or metal, and can be formed having a flat, planar configuration, with one flat side abutting carrier 16 and an opposite flat side facing away from carrier 16.

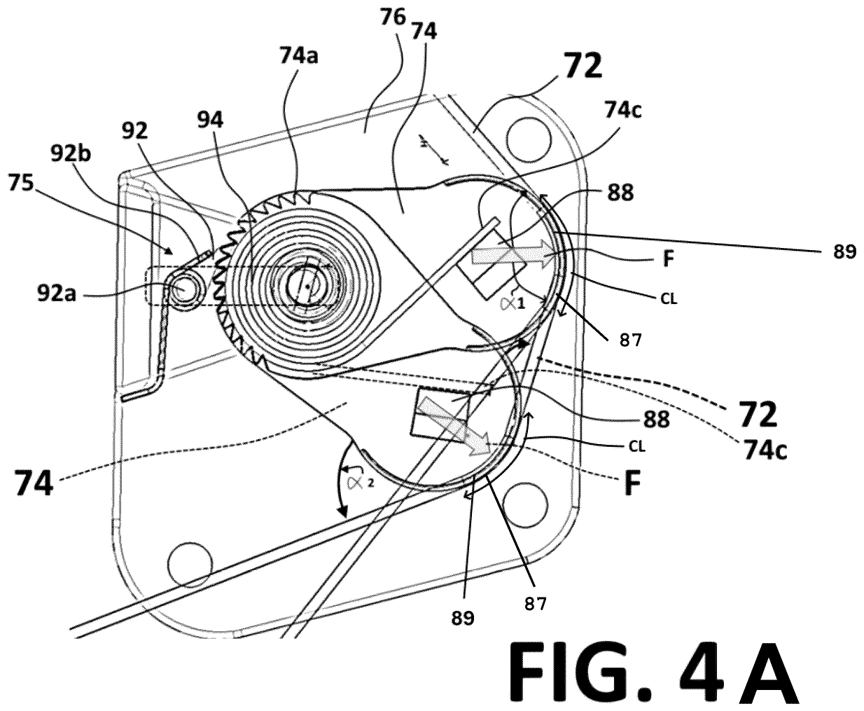

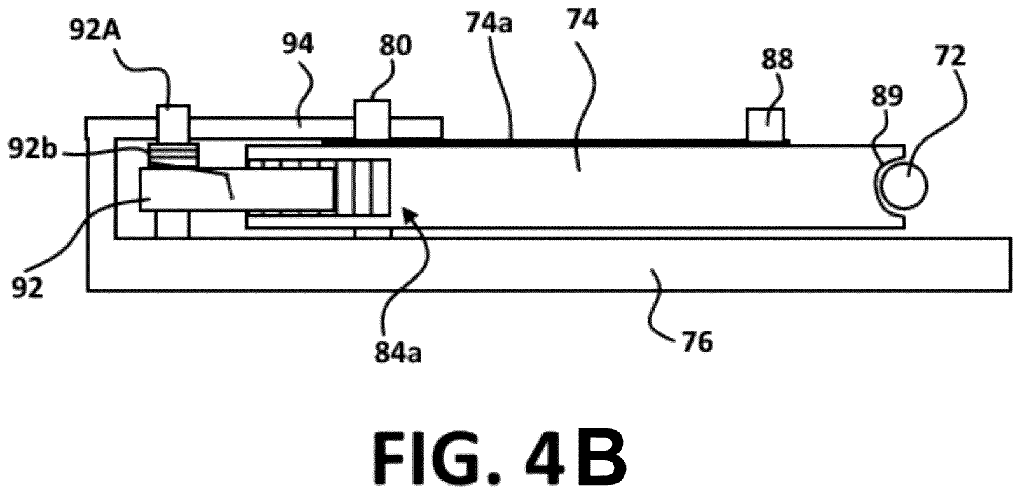

Cam 74 is supported for pivotal movement about a pin axis PA extending laterally outwardly from support body 76. A pin 80 defines pin axis PA for pivotal movement of cam 74 there about (see FIG. 4B). Pin 80 can be fixed to support body 76 via any suitable fixation mechanism, such as a weld joint, rivet, threaded connection, or otherwise. Cam 74 is pivotably supported by the support body 76, via pin 80, for pivotal movement between an initial assembly state position, also referred to as first position (shown in upper solid of FIG. 4A), whereat the cam 74 contacts the cable 72 and deflects the cable 72 over a first angle α1 about the cam 74, and an advanced use state position, also referred to as second position (shown in lower solid of FIG. 4A), whereat the cam 74 contacts the cable 72 and deflects the cable 72 over a second angle α2 about the cam 74, with the second angle α2 being greater than the first angle α1. Cam 74 is biased by a cam biasing member 74a such that cam biasing member 74a imparts a bias on the cam 74 to generate the desired force F to maintain the cam 74 in constant contact with the cable 72 between the first position and the second position. The unidirectional clutch 75 is configured to allow the cam 74 to move from the first position toward the second position, while preventing movement of the cam 74 away from the second position toward the first position. As such, the cam 74 can start in the first position established during initial assembly and automatically move toward the second position under the bias imparted by cam biasing member 74a over the useful life of the cable tensioner 70, such as may occur as a result of wear and/or stretching (relaxing) of the cable 72. Accordingly, cam 74 functions to maintain a predetermined, generally constant amount of tension in the cable 72 to prevent any buildup of slack in the cable 72, with cam 74 being prevented from moving toward the first position by the unidirectional clutch 75, thereby preventing tension in the cable 72 from lessening relative to the initial tension established in cable 72 during assembly.

The cam biasing member 74a is illustrated, by way of example and without limitation, as a spiral torsion spring, and in a non-limiting embodiment, as a flat spiral spring. It is to be recognized that the cam biasing member 74a could be provided as any suitably configured biasing member, with the exemplary embodiment illustrated believed to be optimal to minimize the amount of space occupied thereby. The cam biasing member 74a has a first end 74b fixedly coupled to the pin 80 and a second end 74c biased into constant engagement with a lug 88 fixed to and extending laterally outwardly from the cam 74. As such, cam biasing member 74a is maintained under a constant preload, thereby negating any potential for vibration noise.

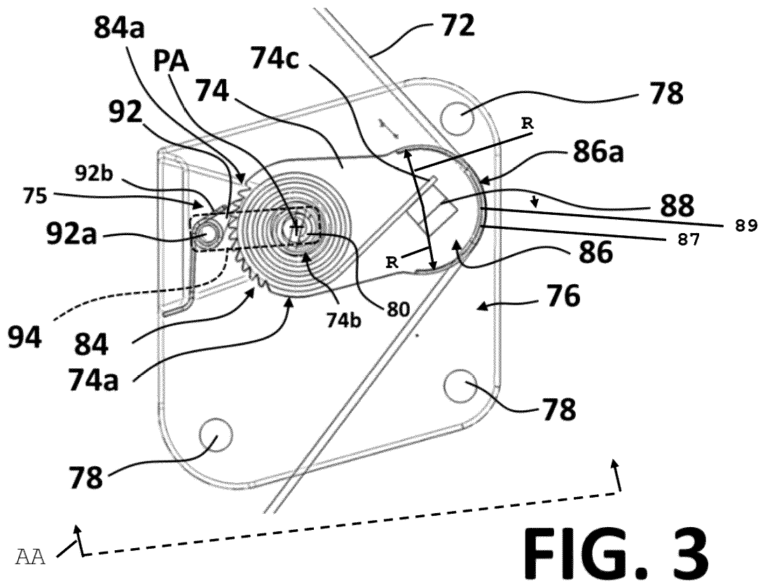

The cam 74 is shown a being oblong shaped, shown by way of example and without limitation as an elongated oval extending lengthwise between a first end 84 and an opposite second end 86. A first end region 84a extending from and immediately adjacent the first end 84 is supported for rotation about the pin axis PA of pin 80 and a second end region 86a extending from and immediately adjacent the second end 86 is configured for constant contact with the cable 72. It is to be recognized that second end region 86a is configured for low friction sliding engagement with cable 72, and could be provided with a rolling member, such as pulley, configured for minimal frictional rolling engagement with cable 72, if desired. Second end region 86a includes a circular surface 87 along which the cable 72 can contact and glide, illustratively shown as defined by a radius R. Illustratively the circular surface 87 is shown having an angle of 180 degrees such that notwithstanding the angle of deflection (see the two different illustrative positions of the cam 74 of FIG. 4A for example) of the cam 74, the cable 72 can glide along a curved surface, and along a similar contact area e.g. the amount of area the cable 72 contacts in any given position can optionally be the same so as not to change the amount of frictional wear of cable deflection depending on the rotational position of the cam 74. In other words, the cable 72 is in contact with the same circular surface 87, for example the same curvature R e.g. the same constant curvature, in any position of the cam 74, shown illustratively as contact length (CL) in FIG. 3 and FIG. 4A. As a result, the wear on the cable 72 does not increase or decrease depending on the cam 74 position due to increasing or decreasing areas of contact between the cam 74 and the cable 72. In another possible configuration, the rotation of the cam 74 to an increase tensioning position causes the cable 72 to contact a smaller contact length (CL) compared to before the rotation of the cam 74 while the cable 72 is exposed to the same curvature R of the circular surface 87. Furthermore, cam 74 comprises a grooved channel 89 to receive at least partially the cable 74 to ensure that the cable 72 does not disengage from the cam 74.

The unidirectional clutch 75 is formed in part by cam 74, wherein the first end region 84a has a high friction roughened peripheral surface, shown including a plurality of ratchet teeth 90, configured for locking engagement with another component of unidirectional clutch 75, shown provided by a pawl 92. The pawl 92 is configured to allow one-way pivotal movement of cam 74, such that pawl 92 ratchets over the plurality of ratchet teeth 90 as cam 74 is pivoted unidirectionally under the bias of cam biasing member 74a to allow the cam 74 to move from the first position toward the second position. As the plurality of ratchet teeth 90 ratchet past pawl 92, pawl 92 locks against at least one of the plurality of ratchet teeth 90 to prevent the cam 74 from moving away from the second position back toward the first position, thereby providing the unidirectional functionality to the unidirectional clutch 75. In further detail, pawl 92 is operably supported for pivotal movement relative to support body 76 by a pawl support arm 94 extending from support body 76, with pawl support arm 94 shown as being generally L-shaped, having a first leg 94a extending upwardly from support body 76 and a second leg 94b extending from the first leg to pin 80. A pawl pin 92a extends between the second leg 94b and support body 76, with pawl 92 being supported by pawl pin 92a for rotation about an axis defined by pawl pin 92a (see FIG. 4A). Pawl 92 is biased into constant engagement with the ratchet teeth 90 by a pawl biasing member 92b, such as a torsion spring. The bias imparted by pawl biasing member 92b allows the pawl 92 to deflect outwardly in ratcheting fashion over one or more of the plurality of ratchet teeth 90 as the cam 74 moves under the bias imparted by cam biasing member 74a from the first position toward the second position. The bias imparted by the pawl biasing member 92b is sufficiently strong to maintain the pawl 92 constant engagement with cam 74 and in locked engagement with at least one of the plurality of ratchet teeth 90 to prevent the cam 74 from moving counterclockwise, as viewed in FIGS. 3 and 4A, away from the second position back toward the first position. As such, over the useful life of cable tensioner 70, cam 74 moves unidirectionally (clockwise, as viewed in FIGS. 3 and 4A) in gradual fashion from the first position toward the second position, with the ratchet teeth 90 ratcheting with pawl 92, as needed, to maintain the generally or substantially constant tension in cable 72. Accordingly, the tension in cable 72 remains substantially constant from the initial assembly of cable tensioner 70 in the cable and pulley-type window lift system 60 to the end of life state of cable tensioner 70.

In accordance with another aspect of the disclosure, a method of maintaining tension within a cable 72 of a cable and pulley-type window lift system 60 of window assembly of a motor vehicle closure panel 12 is provided. The method includes: disposing a cam 74 in contact with the cable 72; biasing the cam 74 with a cam biasing member 74a, and arranging a unidirectional clutch 75 in operable communication with the cam 74 to allow the cam 74 to rotate toward the cable 72 in response to a bias imparted by the cam biasing member 74a from a first position, whereat the cam 74 contacts the cable 72 and deflects the cable 72 over a first angle α1 about the cam 74, to a second position, whereat the cam 74 contacts the cable 72 and deflects the cable 72 over a second angle α2 about the cam 74, the second angle α2 being greater than the first angle α1, wherein the unidirectional clutch 75 prevents the cam 74 from rotating away from the second position toward the first position.

In accordance with another aspect of the disclosure, the method includes providing the unidirectional clutch 75 with a plurality of ratchet teeth 90 on the cam 74 and a pawl 92 biased for ratcheting engagement with the plurality of teeth 90.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cable tensioner for imparting tension on a cable of a powered window system of a motor vehicle closure panel, the cable tensioner, comprising:
a support body;
a cam pivotably supported by the support body for pivotal movement between a first position, whereat the cam contacts the cable and deflects the cable over a first angle about the cam, and a second position, whereat the cam contacts the cable and deflects the cable over a second angle about the cam, the second angle being greater than the first angle;
a cam biasing member imparting a bias on the cam to maintain the cam in constant contact with the cable between the first position and the second position; and
a unidirectional clutch configured to allow the cam to move from the first position toward the second position and to prevent movement of the cam away from the second position toward the first position.

2. The cable tensioner of claim 1, wherein the unidirectional clutch includes a plurality of ratchet teeth and a pawl.

3. The cable tensioner of claim 2, wherein the pawl is biased into engagement with the ratchet teeth by a pawl biasing member.

4. The cable tensioner of claim 3, further including a pin extending laterally outwardly from the support body and a lug extending laterally outwardly from the cam, wherein the cam biasing member has a first end coupled to the pin and a second end biased into engagement with the lug.

5. The cable tensioner of claim 4, wherein the cam biasing member is a spiral torsion spring.

6. The cable tensioner of claim 1, wherein the cam has a first end region supported for rotation about a pin axis of a pin extending laterally from the support body and a second end region configured to be biased into contact with the cable.

7. The cable tensioner of claim 6, wherein the first end region has a plurality of ratchet teeth configured for engagement with a pawl, wherein the pawl is configured to ratchet over the plurality of ratchet teeth to allow the cam to move from the first position toward the second position and to lock against the plurality of ratchet teeth to prevent the cam from moving away from the second position toward the first position.

8. The cable tensioner of claim 7, wherein the pawl is biased into engagement with the ratchet teeth by a pawl biasing member, the pawl biasing member allowing the pawl to deflect in ratcheting fashion over the plurality of ratchet teeth as the cam moves from the first position toward the second position, and maintaining the pawl in locked engagement with at least one of the plurality of ratchet teeth to prevent the cam from moving away from the second position toward the first position.

9. The cable tensioner of claim 8, further including a lug extending laterally outwardly from the cam, wherein the cam biasing member has a first end coupled to the pin and a second end biased into engagement with the lug.

10. The cable tensioner of claim 9, wherein the cam biasing member is a spiral torsion spring.

11. A carrier for a carrier module of a motor vehicle door assembly having an inner panel and an outer panel defining a door panel structure with the inner panel having an opening to an internal door cavity between the inner panel and the outer panel, said carrier comprising:
a carrier body bounded by an outer periphery configured for attachment to the inner panel to at least partially close off the opening;
a cable and pulley-type window lift system operably attached to the carrier body, the cable and pulley-type window lift system having a plurality of pulleys and a cable entrained about the plurality of pulleys;
a support body operably fixed to the carrier body;
a cam supported by the support body for pivotal movement between a first position, whereat the cam contacts the cable and deflects the cable over a first angle about the cam, and a second position, whereat the cam contacts the cable and deflects the cable over a second angle about the cam, the second angle being greater than the first angle;
a cam biasing member imparting a bias on the cam to maintain the cam in constant contact with the cable between the first position and the second position; and
a unidirectional clutch configured to allow the cam to move from the first position toward the second position and to prevent movement of the cam away from the second position toward the first position.

12. The carrier of claim 11, wherein the unidirectional clutch includes a plurality of ratchet teeth and a pawl.

13. The carrier of claim 12, wherein the pawl is biased into engagement with the ratchet teeth by a pawl biasing member.

14. The carrier of claim 13, further including a pin extending laterally outwardly from the support body and a lug extending laterally outwardly from the cam, wherein the cam biasing member has a first end coupled to the pin and a second end biased into engagement with the lug.

15. The carrier of claim 11, wherein the cam has a first end region supported for rotation about a pin axis of a pin extending laterally from the support body and a second end region biased into contact with the cable.

16. The carrier of claim 15, wherein the first end region has a plurality of ratchet teeth configured for engagement with a pawl, wherein the pawl is configured to ratchet over the plurality of ratchet teeth to allow the cam to move from the first position toward the second position and to lock against the plurality of ratchet teeth to prevent the cam from moving away from the second position toward the first position.

17. The carrier of claim 16, wherein the pawl is biased into engagement with the ratchet teeth by a pawl biasing member, the pawl biasing member allowing the pawl to deflect in ratcheting fashion over the plurality of ratchet teeth as the cam moves from the first position toward the second position, and maintaining the pawl in locked engagement with at least one of the plurality of ratchet teeth to prevent the cam from moving away from the second position toward the first position.

18. The carrier of claim 17, further including a lug extending laterally outwardly from the cam, wherein the cam biasing member has a first end coupled to the pin and a second end biased into engagement with the lug.

19. A method of maintaining tension within a cable of a cable and pulley-type window lift system of window assembly of a motor vehicle closure panel, comprising:
disposing a cam in contact with the cable;
biasing the cam with a cam biasing member; and
arranging a unidirectional clutch in operable communication with the cam to allow the cam to rotate toward the cable in response to a bias imparted by the cam biasing member from a first position, whereat the cam contacts the cable and deflects the cable over a first angle about the cam, to a second position, whereat the cam contacts the cable and deflects the cable over a second angle about the cam, the second angle being greater than the first angle, wherein the unidirectional clutch prevents the cam from rotating away from the second position toward the first position.

20. The method of claim 19, further including providing the unidirectional clutch with a plurality of ratchet teeth on the cam and a pawl biased for ratcheting engagement with the plurality of teeth.
